(19) United States
(12) Patent Application Publication
(10) Pub. No.: US 2021/0294128 A1
(43) Pub. Date: Sep. 23, 2021

(54) CONTACT LENS RESTORER

(71) Applicant: SUZHOU 3N BIOLOGICAL TECHNOLOGY CO., LTD, Suzhou (CN)

(72) Inventor: Bixia SUN, Suzhou (CN)

(73) Assignee: SUZHOU 3N BIOLOGICAL TECHNOLOGY CO., LTD, Suzhou (CN)

(21) Appl. No.: 17/264,030

(22) PCT Filed: Jul. 26, 2019
(86) PCT No.: PCT/CN2019/097974

§ 371 Date: Jan. 28, 2021

(30) Foreign Application Priority Data
Aug. 1, 2018 (CN) 201810863170.0

(51) Int. Cl. G02C 13/00; B08B 7/00

(52) U.S. Cl. CPC G02C 13/008; B08B 7/00

(57) ABSTRACT

A contact lens cleaner includes a power supply base (2), a cleaning base (1), and a cleaning mechanism (3). The cleaning base (1) is detachably connected with the power supply base (2). At least one cleaning recess (103) is provided in the cleaning base (1). The cleaning mechanism (3) includes a power supply unit (302) disposed in the power supply base (2) and a plurality of electrodes (301) extending into the cleaning recesses (103) through a bottom of the cleaning recess (103) and electrically connected with the power supply unit (302). The power supply unit (302) includes a circuit board (303), a power supply and a plurality of conductive sheets (306) disposed on the circuit board (303). A plurality of electrode connectors (305) are disposed through a cleaning base mounting groove (201) at the top of the power supply base (2) in a sealed manner. One end of each of the electrode connectors (305) electrically connected with one of the electrodes (301) is elastically retractable, and the other end of each of the electrode connectors (305) electrically connected with one of the conductive sheets (306) is not elastically retractable. The contact lens cleaner can effectively prevent liquid leakage, is convenient to carry, and is easy to use.

### FIELD OF THE INVENTION

The present invention relates to a contact lens cleaning apparatus, and in particular, to a contact lens cleaner.

### BACKGROUND TECHNIQUE

Quite a few people suffering from myopia choose to use contact lenses for beauty or mobility convenience. However, long-term use of contact lenses will cause protein deposition, which will make the contact lens lose of its oxygen permeability and causing damage to the cornea after wearing. Therefore, the contact lenses must be cleaned for reuse after being worn for a certain period of time.

At present, the most commonly used cleaning method of the contact lenses is to put the contact lenses into two containers of a contact lens cleaning box respectively, inject cleaning liquid, and then rub the contact lens with fingers to remove dust, protein deposits, mucus, and oil stains, etc. on the contact lenses, so as to maintain the oxygen permeability of the contact lenses. However, the cleaning method often fails to achieve a good effect due to dirty fingers, and the cleaning process is quite time-consuming.

At present, there are some commercially available contact lens cleaning devices using ultrasonic wave, a heating-type electromagnetic stirrer, ultraviolet light, or ozone. However, 1) since an ultrasonic frequency for cleaning the contact lenses needs to be higher than 100 KHz, the contact lenses are likely to be damaged physically, and a relatively high matching ability between a circuit and the frequency is required, resulting in relatively high production costs; 2) since the heating-type electromagnetic stirrer performs heating and stirring using an electromagnetic principle, when a cleaning agent is added to separate an attachment from the contact lenses, it is possible that a user is scalded due to unintended touch and the contact lenses are damaged at a high heating temperature; 3) although ultraviolet rays have a strong killing effect on bacteria and ozone is a good oxidant and disinfectant, attachments attached to the lens cannot be removed completely.

The contact lens cleaning apparatus in the prior art still has many technical problems, for example, inconvenience in use, and inconvenience in picking and placing, poor waterproofness, low production efficiency, and liquid easily leakage into a power supply base, thus causing damage to the contact lens cleaning device and severely affecting the service life of the contact lens cleaning device.

In view of the foregoing problems, the designer actively makes researches and innovations to create a contact lens cleaner with a new structure, so that the contact lens cleaner is more industrially valuable.

### SUMMARY OF THE INVENTION

To resolve the foregoing technical problems, one object of the present invention is to provide a contact lens cleaner, which can effectively prevent liquid leakage, is convenient to use and carry, is light in weight, and has stable product quality.

To achieve the foregoing objective, the present invention adopts the following technical solutions: A contact lens cleaner is provided, comprising: a power supply base provided with a cleaning base mounting groove at the top thereof; a cleaning base detachably connected with the power supply base and provided with at least one cleaning recess; a cleaning mechanism comprising a power supply unit disposed in the power supply base; and a plurality of electrodes extending into the at least one cleaning recesses through a bottom of the cleaning recesses and electrically connected with the power supply unit. The power supply unit comprises a circuit board and a power supply, and a plurality of conductive sheets are disposed on the circuit board. A plurality of electrode connectors are disposed through the cleaning base mounting groove in a sealed manner, one end of each of the electrode connectors electrically connected with one of the electrodes is elastically retractable, and the other end of each of the electrode connectors electrically connected with one of the conductive sheets on the circuit board is not elastically retractable.

In a further embodiment, the conductive sheets are cambered or arc-shaped conductive sheets, and the conductive sheets are disposed on a surface of the circuit board. Alternatively, the conductive sheets are bending conductive sheets, one end of each of the conductive sheets is fixed on the circuit board, and the other end of each of the conductive sheets is connected with one of the electrode connectors; or one end of each of the conductive sheets is fixed on the circuit board, and the other end of each of the conductive sheets electrically connected with one of the electrode connectors extends out of the circuit board in a horizontal direction; or the conductive sheets disposed on the circuit board are in interference fit with corresponding electrode connectors respectively.

In a further embodiment, the electrode connectors are spring pin connectors, each of the spring pin connectors comprises a pin tube being non-elastic retractable, a spring disposed in the pin tube and a pin shaft being elastic retractable, one end of each of the electrode connectors electrically connected with one of the electrodes is the elastic retractable pin shaft, and the other end of each of the electrode connectors electrically connected with one of the conductive sheets is the non-elastic retractable pin tube.

In a further embodiment, the power supply base comprises an upper housing and a lower housing, the upper housing is closed above the lower housing and defines an electronic component chamber with the lower housing, the power supply unit is disposed in the electronic component chamber, ultrasonic soldering is used between the upper housing and the lower housing, or a sealing ring is disposed on an inner side at a closed position of the upper housing and the lower housing of the power supply base.

In a further embodiment, a power supply cover is disposed on a bottom of the lower housing of the power supply base, ultrasonic soldering is used between the power supply base and the power supply cover, or a sealing ring is disposed on an inner side at a closed position of the power supply base and the power supply cover.

In a further embodiment, the cleaning base comprises a cleaning base body, the cleaning base body comprises an upper housing and a lower housing, the upper housing of the cleaning base body is closed above the lower housing, ultrasonic soldering is used between the upper housing and the lower housing, or a sealing ring is disposed on an inner side at a closed position of the upper housing and the lower housing.

In a further embodiment, a slot is formed in a peripheral edge of the cleaning base mounting groove at the top of the power supply base.

In a further embodiment, a light strip is disposed on an inner side of the slot, the light strip is provided with a light-transmitting plate, and the light strip is electrically connected with the power supply.

In a further embodiment, the light strip is an annular light strip, the light-transmitting plate is an annular light-transmitting plate, and the annular light-transmitting plate is obliquely disposed on an edge of the cleaning base mounting groove.

In a further embodiment, a touch power supply switch is disposed on the power supply base.

In a further embodiment, the cleaning base is provided with a cleaning base cover, the cleaning base cover is provided with a key, the key is disposed corresponding to a cleaning base opening apparatus, and the cleaning base cover is opened automatically by pressing the key.

In a further embodiment, a cleaning recess cover is disposed on the at least one cleaning recess, and the bottom of the at least one cleaning recess is hemispherical.

In a further embodiment, the power supply is a rechargeable power supply, the power supply base is provided with a charging interface, and the charging interface is provided with a sealing cover.

In a further embodiment, the power supply is a rechargeable power supply, a wireless charging chip is disposed in the power supply base, and the power supply base is wirelessly rechargeable.

In a further embodiment, the cleaning base is detachably connected to the power supply base in a manner of engagement of a clamping groove and a buckle, or in a magnetic connection manner, or in a manner of mounting with a fixed connector, and baffle plates are disposed beside each of the electrodes in the at least one cleaning recess.

In a further embodiment, the cleaning base is quadrangular, and the cleaning base mounting groove also is quadrangular.

In the foregoing solutions, various implementations of the present invention have one or more of the following advantages:

(1) The entire contact lens cleaner is of a split-type design. The electrode connectors are disposed at the top of the power supply base in a sealed manner, a plurality of connector through holes are provided on the top of the power supply base, and the electrode connectors and the connector through holes are connected in a sealed manner through tolerance interference fit or through hot melting, thereby improving a waterproofing effect. One end of each of the electrode connectors is elastically retractable, and can be electrically connected to one of the electrodes in the cleaning recesses stably and elastically, and the other end of each of the electrode connectors is closed disk-shaped or block-shaped and is not elastically retractable, but can press against one conductive sheet on the circuit board. The conductive sheets may be elastically deformed, or the conductive sheets and the circuit board are slightly elastically deformed together, or the conductive sheets disposed on the circuit board are in interference fit with the electrode connectors, thereby forming a stable elastic electrical connection. In this way, a stable electrical connection may be formed, while requirements on a mold and the costs are reduced, and assembly efficiency is improved.

(2) In the present invention, the conductive sheets are disposed on the circuit board. The conductive sheets may be in various shapes, but basically one end of each of the conductive sheets should be fixed on the circuit board, and the other end is a free end; or the conductive sheets are cambered or arc-shaped or bending; or one end of each of the conductive sheets extends out of the circuit board in a horizontal direction; or the conductive sheets are disposed at an edge of the circuit board, and the conductive sheets and the circuit board may be slightly elastically deformed under the pressure by the electrode connectors or may be in an interference fit relationship. All the conductive sheets described above may form a stable electric connection under the pressure by the electrode connectors.

(3) In the present invention, a spring pin, or referred to as a spring pin connector, is used as the electrode connector. One end of each of the electrode connectors connected with one of the electrodes is an elastic retractable pin shaft, and the other end of each of the electrode connectors connected with the conductive sheet is a non-elastic retractable pin tube, which is closed disk-shaped or block-shaped. If a user carelessly leaks cleaning liquid into the cleaning base mounting groove at the top of the power supply base, even if a small amount of liquid flows downward along the pin shaft and a peripheral wall of the pin tube, the cleaning liquid does not flow onto the circuit board. Because the electrode connectors are mounted in the cleaning base mounting groove in a sealed manner, and the bottom of the electrode connectors is the bottom of the closed pin tube, so that liquid leakage is avoided.

(4) In the present invention, the power supply base is defined by an upper housing and a lower housing. The upper housing is closed above the lower housing, and defines an electronic component chamber with the lower housing. The power supply unit is disposed in the electronic component chamber, and a bottom of the lower housing is provided with a power supply cover. To improve the waterproof effect of the power supply base and prevent liquid from entering the power supply base through a gap, the upper housing and the lower housing of the power supply base are connected in a sealed manner, and the lower housing and the power supply cover are also connected in a sealed manner. There are a plurality of sealing manners, for example, ultrasonic welding sealing may be adopted, or a sealing ring may be disposed on an inner side at a closed position of the two components for waterproof sealing.

(5) In the present invention, a cleaning base body of the cleaning base comprises an upper housing and a lower housing, and the upper housing is closed above the lower housing. To improve a waterproof effect of the cleaning base body and prevent liquid from entering the cleaning base body through a gap, the upper housing and the lower housing of the cleaning base body are connected in a sealed manner. There are a plurality of sealing manners, for example, ultrasonic welding sealing may be adopted, or a sealing ring may be disposed on an inner side surface at a closed position of the two housings for waterproof sealing.

(6) A slot structure is provided at a peripheral edge, connected to the cleaning base of an inner edge of the cleaning base mounting groove at the top of the power supply base. In this way, on one hand, a user can easily pick and place the cleaning base, and on the other hand, a breathing lamp can be disposed in the slot, so that the cleaning condition can be observed more intuitively. The cleaning base mounting groove is square-shaped, which facilitates fool-proof positioning and picking and placing of the cleaning base correctively.

(7) The touch power supply switch is disposed on the power supply base and can prevent liquid from entering the power supply base through a gap.

(8) The cleaning base cover is provided with a key, the cleaning base is provided with a pressing opening apparatus, and the cleaning base cover is automatically opened when a user presses the key, so that the user can conveniently open the cleaning base without taking out the cleaning base as in a conventional product, thereby increasing the convenience in use.

(9) The cleaning recess is provided with a cleaning recess cover, which can play a role of sealing. The bottom of the cleaning recess is hemispherical, and is designed according to the shape of a human finger, which conforms to the ergonomic design, so that the contact lenses can be easily taken out from the cleaning recesses with a finger, and the contact lenses are not easily damaged. Particularly, the cleaning recess help protect hard contact lenses.

(10) The power supply is a rechargeable power supply. The power supply base is provided with a charging interface, and the charging interface is provided with a sealing cover. In this way, the power supply base can be used for a long time and can prevent liquid leakage. A wireless charging chip is disposed in the power supply base, and the power supply base may be charged wirelessly, which is more convenient.

(11) The cleaning base is detachably connected to the power supply base in a manner of engagement of a clamping groove and a buckle, or in a magnetic connection manner, or in a manner of mounting with a fixed connector, so that the cleaning base is convenient to disassemble. Particularly, the magnetic adsorption facilitates picking and placing. The cleaning base can be taken out for replacement or placed for use without a large force. Electrode baffle plates are disposed beside each of the electrodes in the cleaning recesses to prevent the electrodes from destroying the contact lenses.

(12) In the present invention, due to the ingenious structure design, under the condition of the same product function, the production and assembly of the contact lens cleaner in the present invention are more convenient, the production efficiency is improved, the product yield is improved, the costs are reduced, the contact lens cleaner is more durable, and the user experience is improved obviously.

### BRIEF DESCRIPTION OF THE DRAWINGS

The drawings described herein are provided to further understand the present invention, and are intended to be a part of this application. In the drawing:

FIG. 1 is a three-dimensional view of a contact lens cleaner according to one embodiment of the present invention;

FIG. 2 is a top view of the contact lens cleaner according to one embodiment of the present invention;

FIG. 3 is a three-dimensional view of the contact lens cleaner according to one embodiment of the present invention, wherein an opened cleaning base disposed on a power supply base is shown;

FIG. 4 is a three-dimensional view of a circuit board in a power supply base of the contact lens cleaner according to one embodiment of the present invention;

FIG. 5 is a three-dimensional view of a cleaning base of the contact lens cleaner according to one embodiment of the present invention;

FIG. 6 is a three-dimensional exploded view of the contact lens cleaner according to one embodiment of the present invention;

FIG. 7 is a main exploded view of the contact lens cleaner according to one embodiment of the present invention;

FIG. 8 is an enlarged view of an electrode connector of the contact lens cleaner according to one embodiment of the present invention;

FIG. 9 is a diagram of states of one conductive sheet of the contact lens cleaner according to one embodiment of the present invention; and

FIG. 10 is a front view and a side view of another form of one conductive sheet of the contact lens cleaner according to one embodiment of the present invention.

### DETAILED DESCRIPTION OF THE INVENTION

The following further describes specific implementations of the present invention in detail with reference to the accompanying drawings and the embodiments. The following embodiments are used to describe the present invention, but are not intended to limit the scope of the present invention.

Reference numerals in the accompanying drawings are as follows:

1, Cleaning base; 2, Power supply base; 3, Cleaning mechanism;

101, Cleaning base cover; 102, Cleaning base body; 103, Cleaning recess; 104, Key; 105, Baffle plate; 106, Accessory accommodation groove; 107, Cleaning recess cover;

201, Cleaning base mounting groove; 202, Light strip; 203, Light-transmitting plate; 204, Touch power supply switch; 205, Charging interface; 206, Sealing cover;

301, Electrodes; 302, Power supply unit; 303, Circuit board; 305, Electrode connectors; 306, Conductive sheets.

### First Embodiment

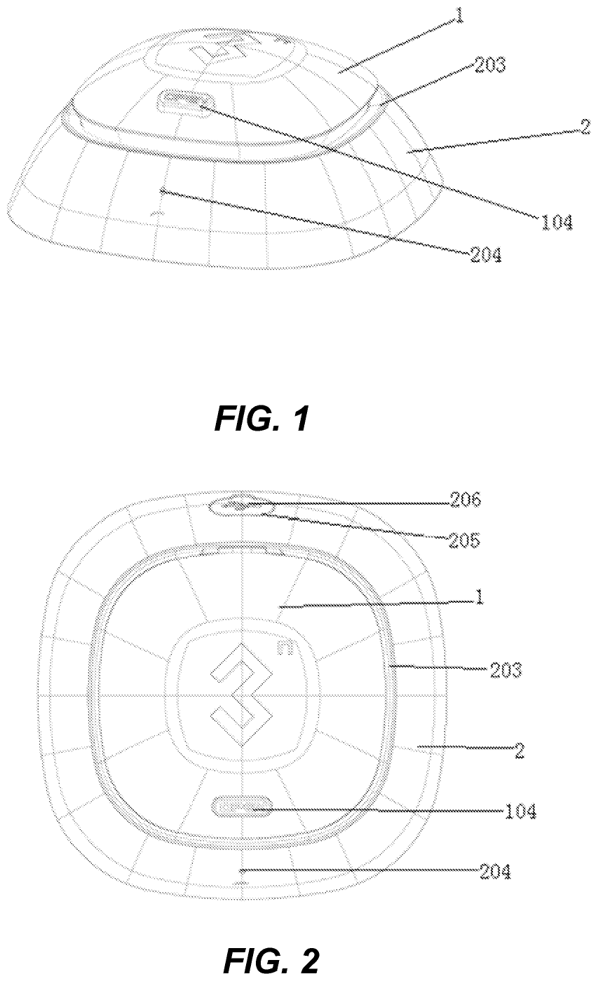

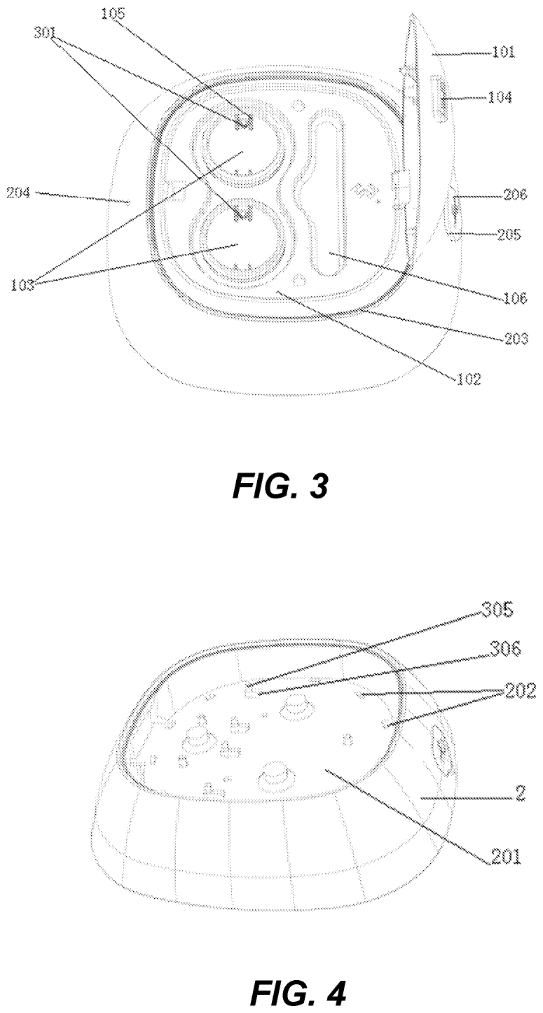

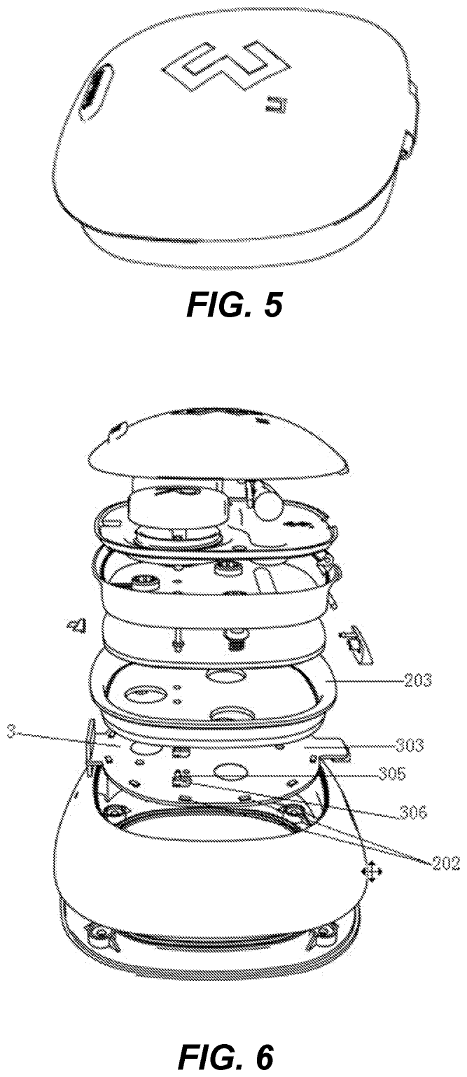

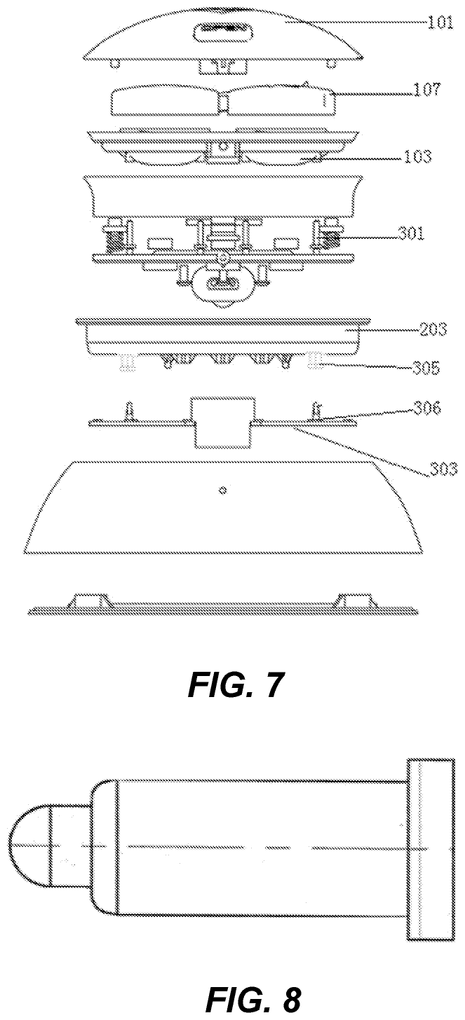

As shown in FIG. 1 to FIG. 10, the present invention provides a contact lens cleaner, including a cleaning base 1, a power supply base 2, and a cleaning mechanism 3. The power supply base 2 is provided with a cleaning base mounting groove 201 at the top thereof. The cleaning base 1 and the power supply base 2 are separated structures. Namely, the cleaning base 1 is detachably connected with the power supply base 2. At least one cleaning recesses 103 is provided in the cleaning base 1. As shown in FIG. 3, two cleaning recesses 103 are provided. A plurality of electrodes 301 are disposed in the cleaning recesses 103, and the electrodes 301 are disposed through a bottom of the cleaning recesses 103. The cleaning mechanism 3 includes a power supply unit 302 disposed in the power supply base 2 and the plurality of electrodes 301 in the cleaning recesses 103 electrically connected to the power supply unit 302. The power supply unit 302 includes a circuit board 303 and a power supply. A plurality of conductive sheets 306 are disposed on the circuit board 303. A plurality of electrode connectors 305 are disposed through the cleaning base mounting groove 201 at the top of the power supply base 2 in a sealed manner. One end of each of the electrode connectors 305 electrically connected with one of the electrodes 301 in the cleaning recesses 103 is elastically retractable. The other end of each of the electrode connectors 305 is not elastically retractable, and is electrically connected with one of the conductive sheets 306 on the circuit board 303. FIG. 6 is a three-dimensional exploded view of the contact lens cleaner according to one embodiment of the present invention, wherein the electrode connectors 305 and the conductive sheets 306 are in connection state. FIG. 7 is a three-dimensional exploded view of the contact lens cleaner according to one embodiment of the present invention, wherein the electrode connectors 305 and the conductive sheets 306 are in separated state. The electrode connectors 305 are disposed on a cover plate on the top of the power supply base 2, and the conductive sheets 306 are disposed on the circuit board 303.

A pogo pin may be used as the electrode connectors 305. The pogo pin is a precision connector applied to electronic products such as a mobile phone, is widely used in semiconductor devices, and plays a role of connection. The pogo pin is a spring pin formed by riveting and prepressing three basic components: a pin shaft, a spring, and a pin tube, through a precision instrument. There is a precision spring structure in the pogo pin.

In the present invention, the entire the contact lens cleaner is of a split-type design. The electrode connectors 305 are disposed at the top of the power supply base 2 in a sealed manner. A plurality of connector through holes are provided on the top of the power supply base 2, and the electrode connectors 305 and the connector through holes are connected in a sealed manner through tolerance interference fit or through hot melting, thereby improving a waterproofing effect. One end of each of the electrode connectors 305 is elastically retractable, and can be electrically connected to one of the electrodes 301 in the cleaning recesses 103 stably and elastically. The other end of each of the electrode connectors 305 is closed disk-shaped or block-shaped and is not elastically retractable, but can press against one conductive sheet on the circuit board 303. The conductive sheets 306 may be elastically deformed, or the conductive sheets 306 and the circuit board 303 are slightly elastically deformed together, or the conductive sheets 306 disposed on the circuit board 303 are in interference fit with the electrode connectors 305, thereby forming a stable elastic electrical connection. In this way, a stable electrical connection may be formed, while requirements on a mold and the costs are reduced, and assembly efficiency is improved.

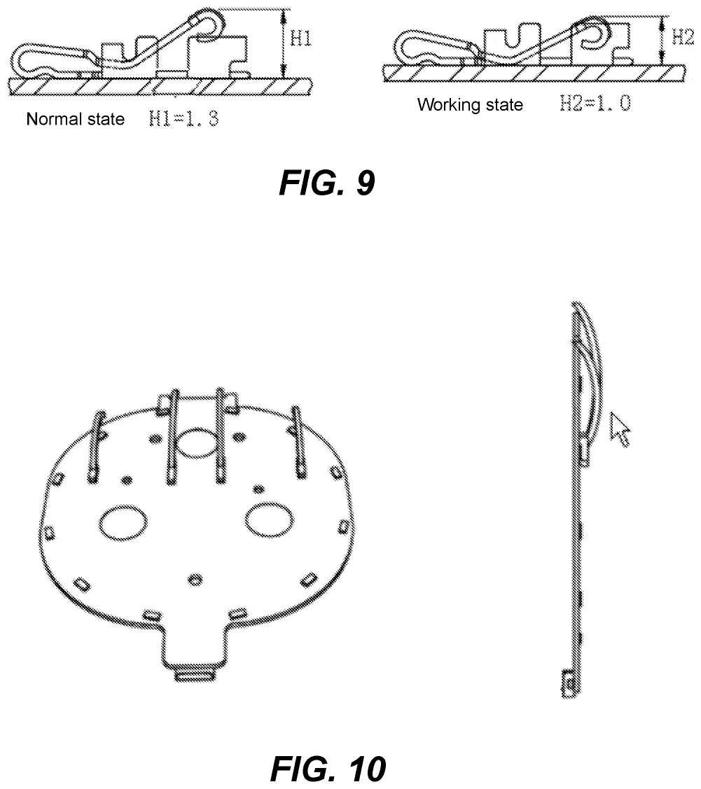

As shown in FIG. 9 and FIG. 10, in the present invention, the conductive sheets 306 are disposed on the circuit board 303. The conductive sheets 306 may be in various shapes, but basically one end of one of the conductive sheets 306 should be fixed on the circuit board 303, and the other end is a free end (as shown in FIG. 9); or the conductive sheet is cambered or arc-shaped or bending; or one end of each of the conductive sheets 306 extends out of the circuit board 303 in a horizontal direction; or the conductive sheets 306 are disposed at an edge of the circuit board 303, and the conductive sheets 306 and the circuit board 303 may be elastically deformed under the pressure by the electrode connectors 305 or may be in interference fit. All the conductive sheets 306 described above may be elastically deformed or may be in interference fit under the pressure by the electrode connectors 305, thereby forming a stable electric connection. As shown in FIG. 9, the left figure is one conductive sheet in a normal state, and the right figure is the one conductive sheet in a working state. It can be seen from the figure that, the conductive sheet in the working state is elastically deformed, so that the electrode connector is stably electrically connected to the conductive sheet.

FIG. 8 is an enlarged view of the electrode connector of the contact lens cleaner according to one embodiment of the present invention. In the present invention, a spring pin comprising a pin tube being non-elastic retractable, a spring disposed in the pin tube and a pin shaft being elastic retractable is used as the electrode connector. One end of one electrode connector connected with one of the electrodes 301 is the elastic retractable pin shaft, and the other end of the one electrode connector connected with the conductive sheet is the non-elastic retractable pin tube, which is closed disk-shaped or block-shaped. If a user carelessly leaks cleaning liquid into the cleaning base mounting groove 201 at the top of the power supply base 2, even if a small amount of liquid flows downward along the pin shaft and a peripheral wall of the pin tube, the cleaning liquid does not flow onto the circuit board 303. Because the electrode connectors 305 are mounted in the cleaning base mounting groove 201 in a sealed manner, and the bottom of each of the electrode connectors 305 is the bottom of the closed pin tube, so that liquid leakage is avoided.

It should be noted that the cleaning base 1 and the power supply base 2 are of a type of detachable design, and are detachably connected. The cleaning base 1 and the power supply base 2 may be connected in various manners. The cleaning base 1 is detachably connected to the power supply base 2 in a manner of engagement of a clamping groove and a buckle, or in a magnetic connection manner, or in a manner of mounting with a fixed connector, so that the cleaning base 1 is convenient to disassemble. Particularly, the magnetic adsorption facilitates picking and placing. The cleaning base 1 can be taken out for replacement or placed for use without a large force. Further, electrode baffle plates 105 are disposed beside each of the electrodes 301 of the cleaning recesses 103, to prevent the electrodes 301 from destroying contact lenses.

The working principle of the present invention is based on a protein electrophoresis technology, that is, charged particles move towards an oppositely charged electrode under the action of an electric field. This is referred to as electrophoresis (EP). A protein is a molecule with complete biological activity formed by one or more polypeptide chains combined in respective special combination modes. The protein is an ampholyte. When the protein molecule is at an isoelectric point, an electrostatic charge of the protein molecule is zero, and the protein molecule is usually positively charged in a slightly acidic solution, and is negatively charged in a slightly alkaline solution. When the electrodes 301 are powered on, because the power supply unit 302, the electrodes 301, and a care solution form an electrical path, a specific electric potential difference is applied between the two electrodes 301, proteins adhered to the contact lenses are separated from the contact lenses due to the action of the electric potential difference. The proteins move to one of the electrodes 301 in the care solution, and finally are adsorbed on the surface of the electrode, thereby cleaning the contact lenses, and restoring a good use state of the contact lenses.

To tightly connect the electrodes 301 and the cleaning base 1 and prevent the care solution from leaking downward from the connection position, outer surfaces of the electrodes 301 are provided with rough surfaces, and the electrodes 301 are integrally formed with the cleaning base 1. The rough surfaces may be formed in a plurality of manners, for example, a texture is provided on the surfaces of the electrodes 301, sandblast is performed on the surfaces of the electrodes 301, or one or more electroplated layers are coated on the surfaces of the electrodes 301, to generate the rough surfaces. The electrodes 301 with the rough surfaces are integrally formed in the cleaning base 1 through injection molding. In this way, the cylindrical electrodes 301 can be prevented from rotating, shaking, moving up and down, generating gaps, and the like, and liquid leakage at the positions of the electrodes 301 in the cleaning base 1 can be prevented.

It should be noted that the power supply unit 302 includes a circuit board 303 and a power supply, and the power supply is configured to supply power to the circuit board 303. Any power supply capable of implementing this function falls within the scope of protection, structural changes due to different power supplies also fall within the scope of protection of the present invention. The power supply is selected to be a built-in dry battery, a rechargeable lithium battery, or a button cell battery, or may be an external power supply connector. The circuit board 303 is configured to adjust a specific electric potential difference, a current value, and a power-on time between the two electrodes 301, and any circuit board capable of implementing this function should fall within the scope of protection of the contact lens cleaner of the present invention. The adjustment of the electric potential difference, the current value, and the power-on time is not limited to the complexity of an electronic component such as a resistor, a capacitor, a chip, or an integrated circuit, or to the presence or absence of control of a computer software program.

### Second Embodiment

As shown in FIG. 1 and FIG. 7, an annular slot is formed in a peripheral edge, connected to the cleaning base 1, of an inner edge of the cleaning base mounting groove 201 at the top of the power supply base 2. An edge of the cleaning base mounting groove 201 at the top of the power supply base 2 is provided with a specific inclined slope. In this way, when the cleaning base 1 is mounted in the cleaning base mounting groove 201, the annular slot is formed in the peripheral edge, connected to the cleaning base 1, of the inner edge of the cleaning base mounting groove 201. In this way, on one hand, a user can easily pick and place the cleaning base 1, and on the other hand, a breathing lamp may be disposed at an inner side of the annular slot. A light-transmitting plate (preferably, the light-transmitting plate is an acrylic plate) 203 is disposed on the breathing lamp, and the breathing lamp is electrically connected to the power supply. In this way, a user can observe the cleaning condition more intuitively, thereby greatly improving the user experience. In one embodiment, a light strip 202 serves as the breathing lamp.

It should be noted that overall shapes of the cleaning base 1 and the cleaning base mounting groove 201 match each other. The cleaning base 1 and the cleaning base mounting groove 201 may be a cylinder and a cylindrical groove, or a hemisphere and a hemispherical groove, or a hexagonal prism and a hexagonal prism groove, and the like. Preferably, the cleaning base 1 is quadrangular and the corresponding cleaning base mounting groove 201 is a quadrangular groove, which facilitates foolproof positioning and is beneficial to pick and place the cleaning base 1 correctly. In addition, an indication mark may be further provided on the cleaning base 1, which is beneficial to position and place the cleaning base 1 correctly.

To further improve user experience, the cleaning base 1 is provided with a cleaning base cover 101, and the cleaning base cover 101 is provided with a key 104. The key 104 is provided corresponding to a cleaning base opening apparatus, and the cleaning base cover 101 is automatically opened when a user presses the key 104, so that the user can conveniently open the cleaning base 1 without taking out the cleaning base 1 as in a conventional product, thereby increasing the convenience in use.

Further, the cleaning recesses 103 are provided with a cleaning recess cover 107, which can play a role of sealing. The bottom of the cleaning recess 103 is hemispherical, and is designed according to the shape of a human finger, which conforms to the ergonomic design, so that the contact lenses can be easily taken out from the cleaning recesses 103 with a finger, and the contact lenses are not easily damaged. Particularly, the cleaning recesses 103 help protect hard contact lenses.

### Third Embodiment

As shown in FIG. 6 and FIG. 7, the power supply base 2 comprises an upper housing and a lower housing, the upper housing is closed above the lower housing and defines an electronic component chamber with the lower housing. The power supply unit 302 is disposed in the electronic component chamber. The upper housing and the lower housing are connected in a sealed manner. Such a sealing is mainly intended to prevent liquid from entering the power supply unit 302 through a gap between the housings of the power supply base 2, resulting in product damage.

Further, a power supply cover is provided on a bottom of the lower housing of the power supply base 2. The lower housing is also connected to the power supply cover in a sealed manner. It should be noted that there are many manners for sealing. For example, ultrasonic welding may be used for sealing, or a sealing ring may be disposed on an inner side surface at a closed position of the two components for waterproof sealing.

Similarly, to increase a waterproof effect of the cleaning base body 102 and prevent liquid from entering the cleaning base body 102 through a gap, the cleaning base 1 is provided with a cleaning base body 102. The cleaning base body 102 comprises an upper housing and a lower housing. The upper housing is closed above the lower housing, and the upper housing is connected to the lower housing in a sealed manner. For example, ultrasonic welding may be used for sealing, or a sealing ring may be disposed on an inner side surface at a closed position of the upper housing and the lower housing.

Further, a key power supply switch on the power supply base 2 may be replaced with a touch power supply switch 204, to improve the technological aesthetics of the contact lens cleaner while preventing liquid from entering the power supply base 2 through the gap, thereby greatly improving the waterproof effect of the power supply base 2.

It should be noted that the power supply in the present invention may be a rechargeable power supply, the power supply base 2 is provided with a charging interface 205, and the charging interface 205 is provided with a sealing cover 206. In this way, the power supply base 2 can be used for a long time, and liquid leakage is prevented. Further, a wireless charging chip is disposed in the power supply base 2, and the power supply base 2 may be charged wirelessly and is more convenient.

The embodiments are only for describing the technical concepts and features of the present invention, and are intended to enable a person skilled in the art to understand the present invention and to practice the same, and are not intended to limit the scope of the present invention. Equivalent variation and modification made within the spirit of the present invention shall fall within the scope of the present invention.

What is claimed is:

1. A contact lens cleaner, comprising:
a power supply base provided with a cleaning base mounting groove at the top thereof;
a cleaning base detachably connected with the power supply base and provided with at least one cleaning recess; and
a cleaning mechanism comprising a power supply unit disposed in the power supply base, and a plurality of electrodes extending into the at least one cleaning recesses through a bottom of the cleaning recess and electrically connected with the power supply unit;
wherein the power supply unit comprises a circuit board and a power supply, and a plurality of conductive sheets are disposed on the circuit board; and
wherein a plurality of electrode connectors are disposed through the cleaning base mounting groove in a sealed manner, one end of each of the electrode connectors electrically connected with one of the electrodes is elastically retractable, and the other end of each of the electrode connectors electrically connected with one of the conductive sheets on the circuit board is not elastically retractable.

2. The contact lens cleaner according to claim 1, wherein the conductive sheets are cambered or arc-shaped conductive sheets, and the conductive sheets are disposed on a surface of the circuit board; or
the conductive sheets are bending conductive sheets, one end of each of the conductive sheets is fixed on the circuit board, and the other end of each of the conductive sheets is connected with one of the electrode connectors; or
one end of each of the conductive sheets is fixed on the circuit board, and the other end of each of the conductive sheets electrically connected with one of the electrode connectors extends out of the circuit board in a horizontal direction; or
the conductive sheets disposed on the circuit board are in interference fit with corresponding electrode connectors respectively.

3. The contact lens cleaner according to claim 1, wherein the electrode connectors are spring pin connectors, each of the spring pin connectors comprises a pin tube being non-elastic retractable, a spring disposed in the pin tube and a pin shaft being elastic retractable, one end of each of the electrode connectors electrically connected with one of the electrodes is the elastic retractable pin shaft, and the other end of each of the electrode connectors electrically connected with one of the conductive sheets is the non-elastic retractable pin tube.

4. The contact lens cleaner according to claim 1, wherein the power supply base comprises an upper housing and a lower housing, the upper housing is closed above the lower housing and defines an electronic component chamber with the lower housing, the power supply unit is disposed in the electronic component chamber, ultrasonic soldering is used between the upper housing and the lower housing, or a sealing ring is disposed on an inner side at a closed position of the upper housing and the lower housing of the power supply base.

5. The contact lens cleaner according to claim 1, wherein a power supply cover is disposed on a bottom of the lower housing of the power supply base, ultrasonic soldering is used between the power supply base and the power supply cover, or a sealing ring is disposed on an inner side at a closed position of the power supply base and the power supply cover.

6. The contact lens cleaner according to claim 1, wherein the cleaning base comprises a cleaning base body, the cleaning base body comprises an upper housing and a lower housing, the upper housing of the cleaning base body is closed above the lower housing, ultrasonic soldering is used between the upper housing and the lower housing, or a sealing ring is disposed on an inner side at a closed position of the upper housing and the lower housing.

7. The contact lens cleaner according to claim 1, wherein a slot is formed in a peripheral edge of the cleaning base mounting groove at the top of the power supply base.

8. The contact lens cleaner according to claim 7, wherein a light strip is disposed on an inner side of the slot, the light strip is provided with a light-transmitting plate, and the light strip is electrically connected with the power supply.

9. The contact lens cleaner according to claim 8, wherein the light strip is an annular light strip, the light-transmitting plate is an annular light-transmitting plate, and the annular light-transmitting plate is obliquely disposed on an edge of the cleaning base mounting groove.

10. The contact lens cleaner according to claim 1, wherein a touch power supply switch is disposed on the power supply base.

11. The contact lens cleaner according to claim 1, wherein the cleaning base is provided with a cleaning base cover, the cleaning base cover is provided with a key, the key is disposed corresponding to a cleaning base opening apparatus, and the cleaning base cover is opened automatically by pressing the key.

12. The contact lens cleaner according to claim 1, wherein a cleaning recess cover is disposed on the at least one cleaning recess, and the bottom of the at least one cleaning recess is hemispherical.

13. The contact lens cleaner according to claim 1, wherein the power supply is a rechargeable power supply, the power supply base is provided with a charging interface, and the charging interface is provided with a sealing cover.

14. The contact lens cleaner according to claim 1, wherein the power supply is a rechargeable power supply, a wireless charging chip is disposed in the power supply base, and the power supply base is wirelessly rechargeable.

15. The contact lens cleaner according to claim 1, wherein the cleaning base is detachably connected to the power supply base in a manner of engagement of a clamping groove and a buckle, or in a magnetic connection manner, or in a manner of mounting with a fixed connector, and baffle plates are disposed beside each of the electrodes.

16. The contact lens cleaner according to claim 1, wherein the cleaning base is quadrangular, and the cleaning base mounting groove also is quadrangular.
